(19) United States
(12) Patent Application Publication
(10) Pub. No.: US 2007/0216810 A1
(43) Pub. Date: Sep. 20, 2007

(54) IMAGE COMPOSITING METHOD AND APPARATUS

(75) Inventors: Kyung-Chul Min, Seoul (KR); Se-Jin Kang, Seoul (KR); Sang-Hyung Park, Gyeonggi-do (KR)

Correspondence Address: BLACKWELL SANDERS LLP, 720 OLIVE STREET, SUITE 2400, ST. LOUIS, MO, 63101, US

(73) Assignee: MTEKVISION CO., LTD., Seoul (KR)

(21) Appl. No.: 11/575,898

(22) PCT Filed: Mar. 10, 2005
(86) PCT No.: PCT/KR05/00677

§ 371 Date: Apr. 23, 2007

(30) Foreign Application Priority Data
Sep. 24, 2004 (KR) 10-2004-0076812

(51) Int. Cl. H04N 5/265

(52) U.S. Cl. 348/586

(57) ABSTRACT

Image combining method and apparatus are disclosed. The Image combining method according to the present invention generates an update background image by changing a value of region classification bit in pixel data value of an original background image to a corresponding region classification value. Then, the update background image is displayed on a background region, and a picture image inputted through camera is displayed on a preview region. If a capture instruction is inputted, a digital image corresponding to the displayed update background image and the picture image is generated and stored. According to the present invention, additional format data is not needed when combining images such that an efficient use of memory is possible.

### FIELD OF THE INVENTION

The present invention relates to an image combining method and apparatus, more specifically to a method and apparatus for generating a combined image using plural picture images.

### BACKGROUND OF THE INVENTION

Recently, many image file generating devices (e.g., digital cameras, camera phones), which convert an external image into an image file in the form of electronic file to avail duplication and transfer, are developed and marketed.

Camera phones refer to cellular phones with a function of digital camera for portability and ease of use. A user can take a picture and generate an electronic file (i.e., image file) to output on a display or use as a wallpaper or transfer to other users via e-mail.

Conventional image file generating devices, such as camera phones, could generate an image file of an external image as it was, but could not generate an image file of the user's own or with a unique message (e.g., expression of love). Thus, there have been a number of attempts to overcome this shortcoming by, for example, adding a superimpose function.

Superimposing refers to overlapping an external signal or picture signal with another picture signal. For example, a picture signal can be overlaid with a caption or date, using the superimpose function in television broadcasting or camera phones.

In the conventional method for generating a combined image using the superimpose technique, a picture, characters, or a scene to be combined with is stored first in the memory and then is combined with an external picture.

Hereinafter, the conventional method for generating a combined image using the superimpose technique will be described briefly.

FIG. 1 is a flowchart showing the conventional method for generating a combined image by the superimpose technique.

Referring to FIG. 1, on initiating the camera function, the image file generating device outputs an external picture, which is inputted through a camera lens, on a display (step 105). At this time, the external picture from the camera lens may be converted into digital data to be temporarily stored in the memory and then outputted on the display.

At step 110, the image file generating device checks whether the superimpose function is selected. If the superimpose function is not selected, step 105 is repeated, but, if the superimpose function is selected, the method proceeds to step 115 to extract one of the pre-stored background images and output to the display. These background images can be used to perform the superimpose function.

In step 120, the image file generating device receives a selection of background image from the user.

Later in step 125, the image file generating device reads format data stored in a specific region (format data storing region) of the memory. Format data contains information on which region of the background image will function as a background region and which region will function as a preview region (i.e., where the external picture is displayed). In step 130, the image file generating device writes the selected background image, which was selected in step 120, in a specific region (i.e., background image storing region) of the memory. At this time, the background image to be written may be modified to be associated with the format data extracted in step 125. The usage example of preview memory for generating the combined image is shown in FIG. 5. Namely, in order to generate the combined image, the format data and a background image are stored in separate regions of memory.

In step 135, the image file generating device reads the background image from the background image storing region, and in step 140 outputs the image corresponding to each pixel data value (i.e., the background image from the memory or the external image from the camera lens) on the display. At this time, in association with the format data of step 125, part of the background image corresponding to the background region and the external image are displayed on the background region and the preview region, respectively.

In step 145, the image file generating device determines whether or not the user inputs a capture instruction. If there is no capture instruction, the method returns to step 140, but if there is a capture instruction, the method proceeds to step 150 to generate an electronic file (i.e., a digital image) corresponding to the combined image being displayed on the display and store in the memory. Through aforementioned steps, the user can take a picture with various background images (e.g., a flower garden image).

As described above, since image file generating devices with the conventional superimpose function bad to equip additional memory or storing regions for separately storing background images and format data, efficient use of memory was impossible.

Also, since image file generating devices with the conventional superimpose function had to use a plurality of data stored in additional memory or storing region and determine whether each pixel data value corresponded to the background region or preview region when generating a combined image, the efficiency of data processing was low.

### DETAILED DESCRIPTION OF THE INVENTION

Technical Objectives

The objective of the present invention, to overcome the aforementioned shortcomings, is to provide an image combining method and apparatus that can provide an efficient use of memory by eliminating the need for additional format data and additional memory when generating a combined image.

Another objective of the present invention is to provide an image combining method and apparatus that can increase the efficiency of data processing by using a minimum amount of data value, when combining images, to speed up the determination of whether each pixel corresponds to the background region or preview region.

Technical Solution

To achieve aforementioned objects, one aspect of the present invention provides a method for combining images in an image file generating device with camera, comprising: generating an update background image by changing the value of a region classification bit in pixel data value of an original background image selected from one or more original background images to a region classification value corresponding to each pixel region, wherein the pixel region is either a background region or a preview region; displaying the background region using the update background image and displaying the preview region using a picture image corresponding to an external picture inputted through the camera, wherein the background region and the preview region are identified by the region classification value; and generating and storing a digital image corresponding to the displayed update background image and the displayed picture image when a capture instruction is inputted, as well as an image file generating device and a readable medium for combining a plurality of images.

The preview region is filled with an arbitrary color in the original background image and each pixel data value corresponding to the preview region has data value corresponding to the color.

The region classification bit is the LSB (Least Significant Bit) of the pixel data value, being one or more bits existing in an arbitrary location.

The region classification value is classified into either the background region or the preview region, the region classification value being assigned with a binary value of 0 or 1.

Another aspect of the present invention provides an image file generating device with camera for combining a plurality of images, comprising: a key input part, receiving a selection data of an arbitrary original background image selected from one or more original background images and a capture instruction; a controller, generating an update background image by changing a value of region classification bit in pixel data value of the original background image corresponding to the selection data to a region classification value corresponding to each pixel region, wherein the pixel region is either a background region or a preview region; a display, under the control of the controller, displaying the background region using the update background image and displaying the preview region using a picture image corresponding to an external picture inputted through the camera, wherein the background region and the preview region are identified by the region classification value; a digital image generating part, under the control of the controller, generating a digital image corresponding to the displayed update background image and the displayed picture image when the capture instruction is inputted; and a memory, storing one or more original background images, the update background image, and the digital image.

### BRIEF DESCRIPTION OF THE DRAWINGS

FIG. 1 is a flowchart showing the conventional method for combining images by the superimpose technique;

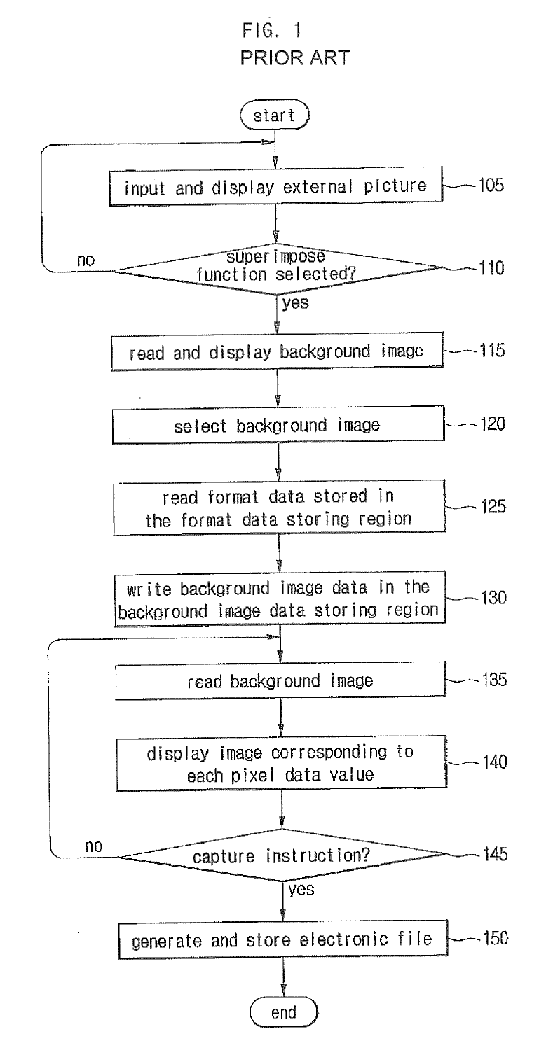

FIG. 2 is a block diagram of an image file generating device according to a preferred embodiment of the present invention;

FIG. 3 is a flowchart of a method for combining images using the superimpose technique according to a preferred embodiment of the present invention;

FIG. 4 illustrates an update state of region classification bit according to a preferred embodiment of the present invention;

FIG. 5 illustrates an example of preview memory usage according to a preferred embodiment of the present invention; and

FIG. 6 illustrates a screen display of a combined image using the superimpose technique according to a preferred embodiment of the present invention.

200: image file generating device

210: camera part

215 telecommunication part

220: audio signal I/O

225: key input part

230: video information display

235: memory

240: controller

### Embodiment

It is needed to refer to the accompanying drawings for illustrating a preferred embodiment of the present invention and description thereof to fully understand the present invention and the advantages of the present invention in operation and the objectives being achieved by the present invention.

Hereinafter, a preferred embodiment of the present invention will be described with the accompanying drawings. In description, an identical number will be used to indicate the same element regardless of the drawing number for the purpose of helping understand the present invention.

The superimpose technique according to the present invention can be applied generally to all kinds of image file generating devices, such as digital cameras, camera phones, web cameras, which generate an image file from an external image. However, hereinafter the case of applying the superimpose technique to the camera phone will be mainly described for the convenience of description.

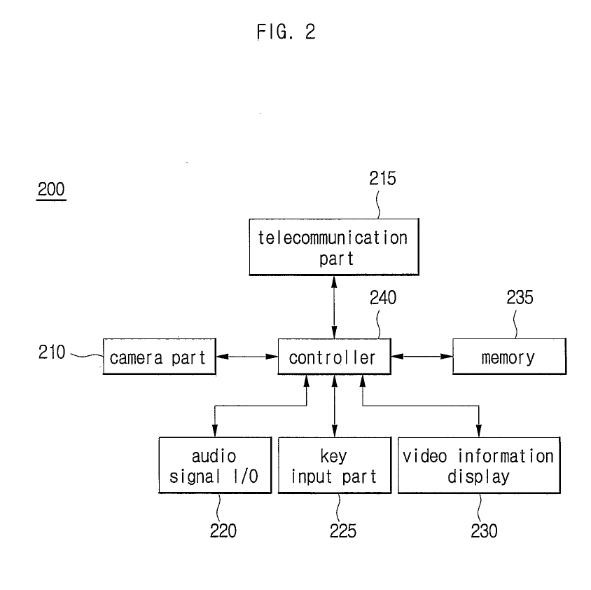

FIG. 2 is a block diagram of an image file generating device according to a preferred embodiment of the present invention.

Referring to FIG. 2, the image file generating device 200 comprises a camera part 210, a telecommunication part 215, an audio signal 1/0 220, a key input part 225, a video information display 230, a memory 235, and a controller 240.

The camera part 210, which converts the external picture into digital data, may comprise lens, CCD (Charge Coupled Device), CDS/AGC (Correlated Double Sampling/Auto Gain Control), ADC (Analogue-to-Digital Converter), DSP, and digital image generating part.

The lens receives an image of external picture (i.e., subject) and delivers to the CCD. The CCD converts an optical signal received from the lens into an electrical signal (captured picture signal) to output. The CDS/AGC eliminates noise from the captured picture signal and controls gain. Generally, the CCD and CDS/AGC may be embodied as a CMOS (Complementary Metal Oxide Semiconductor sensor) chip.

The ADC converts a portion for one field of the captured picture signal, which was gain-controlled by the CDS/AGC, into a digital signal to output to the DSP (Digital Signal Processor). The DSP processes the portion for one field of the digitally-converted captured signal to generate a video signal(Y—luminance signal, C—color signal) in a predetermined method (e.g., NTSC (National Television System Committee), PAL (Phase Alternation by Line)). Then, the DSP under the control of the controller 240 delivers the video signal (Y, C) to the digital image generating part or the video information display 230 for display. If a user pushes a capture button (e.g., camera shutter) of the image file generating device 200, the DSP delivers the captured video signal to the digital image generating part, and stores the digital image generated by the digital image generating part in the memory 235. However, until the user pushes the capture button, the DSP under the control of the controller 240 stores the video signal temporarily in the memory 235 then has it displayed on the video information display 230. At this time, it is possible that the memory 235 for storing the digital image and the memory 235 for temporarily storing the video signal are separate memory means or separate regions in the same memory means. Moreover, when temporarily stored in the memory 235, the video signal is in the digital data format, such as binary code and hexadecimal code. Also, the digital image generating part can convert the video signal from the DSP into a predetermined data format (e.g., JPEG) and compress by a predetermined ratio to store in the memory 235, and in the case of performing the superimpose function, generate a superimposed image, which consists of the background image appearing on the background region and the external image appearing on the preview region, to store in the memory 235.

The telecommunication part 215 makes it possible for the image file generating device 200 to work as a mobile terminal. In other words, the telecommunication part under the control of the controller 240 down-converts and demodulates an RF signal received through an antenna to output through the audio signal I/O 220, and modulates and up-converts a signal from the audio signal I/O 220 into an RF signal to transmit through the antenna via air.

The audio signal I/O 220 can be divided into an audio signal input part (e.g., microphone) and an audio signal output part (e.g., speaker).

The key input part 225 can comprise numeric keys, function keys, plural keys for controlling (e.g., image capture, store, etc) the camera part 210, and a function key for performing the superimpose function. A key input signal corresponding to the key pushed by the user is applied to the controller 240 to perform the corresponding operation.

The video information display 230, e.g., LCD, is means for displaying an image or characters.

The memory 235 stores an operating system of the image file generating device 200, more than one background image for performing the superimpose function, an external picture image that is inputted in real time and temporarily stored, the digital image (e.g., an electronic file corresponding to the external picture, a superimposed image consisting of the background image appearing on the background region and the external image appearing on the preview region, etc) that the digital image generating part generates, etc. It is apparent that the memory 235 can consist of a plurality of memories or a plurality of storing regions according to the type of data stored therein. Also, it is possible to assign a temporary memory (i.e., preview memory) for temporarily storing data (e.g., real-time external picture image and/or background image) to be displayed real time on the video information display 230 into one of the regions in the memory 230, but the temporary memory can be located within the controller 240. The memory 235 may be embodied with an SRAM (Static Random Access Memory) or an SDRAM (Synchronous Dynamic Random Access Memory) for high-speed processing and easy control.

The controller 240 controls the camera part 210, the telecommunication part 215, the audio signal 1/0 220, the key input part 225, the video information display 230, and the memory 235 in order to perform aforementioned functions. Also, when temporarily duplicating a background image to a certain region of the memory 235 or an additional memory for the purpose of performing the superimpose function, the controller 240 stores any bit value of each pixel data value consisting of the background image after changing to a predetermined value (e.g., 0 or 1 in case of binary code). The arbitrary bit of each pixel data value changing to a predetermined value to recognize whether the pixel corresponds to the background region or the preview region can be more than one bit or in any position. For the convenience of description, however, the bit is assumed to be the LSB (Least Significant Bit) hereinafter. Also, the scheme of using the LSB as a region classification bit has advantages such as decreasing the heterogeneity from the original image as well as the easy region classification. The aforementioned function of the controller 240 will be described in detail with the accompanying drawings.

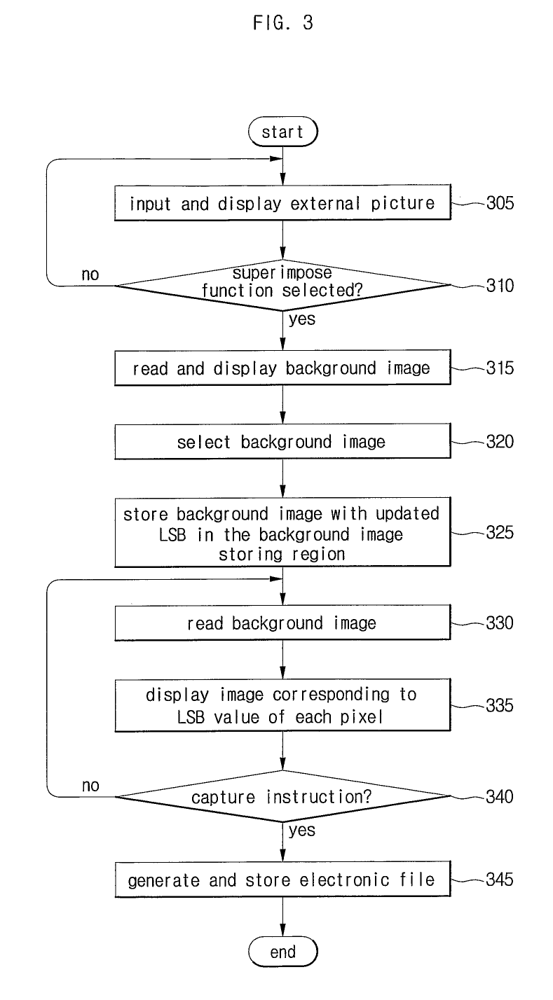

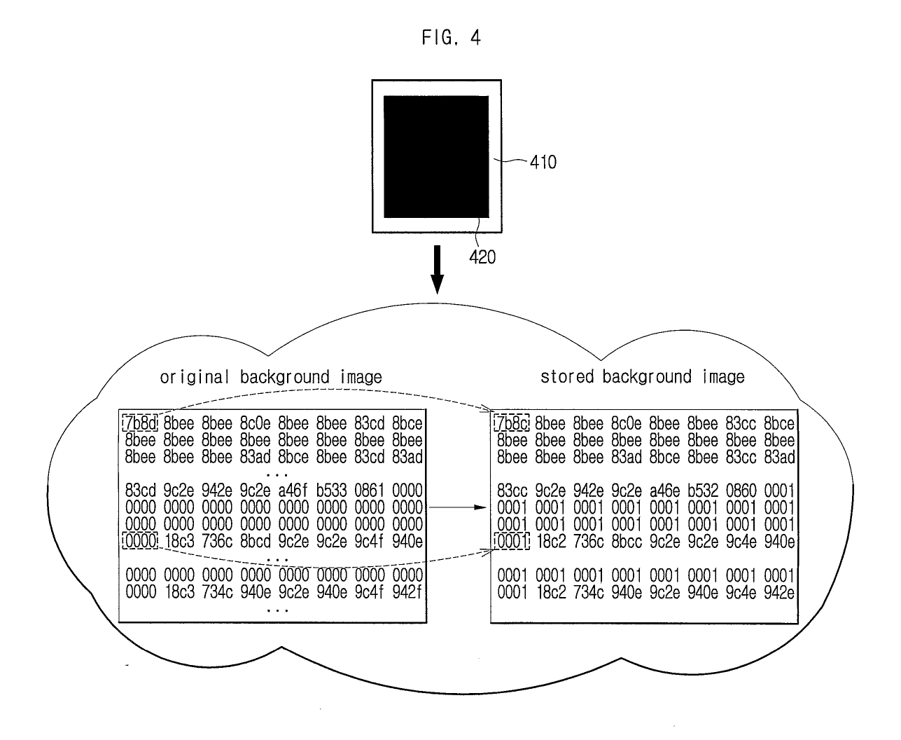

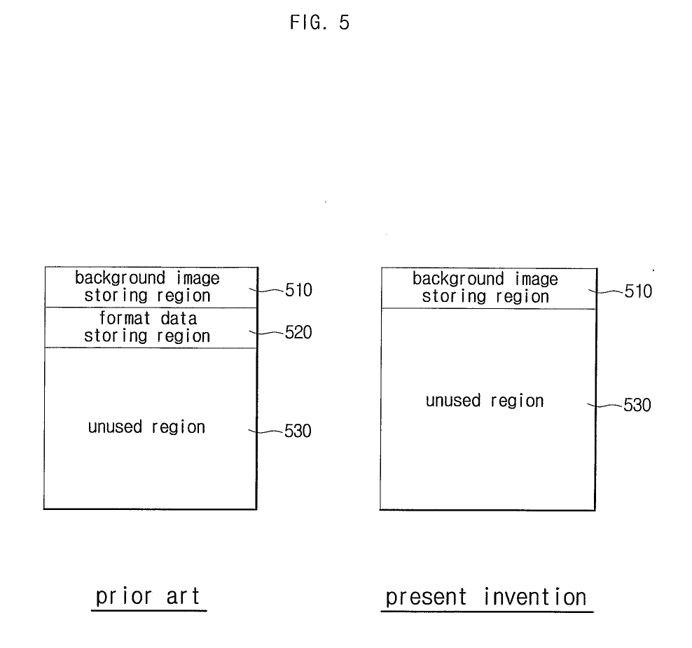

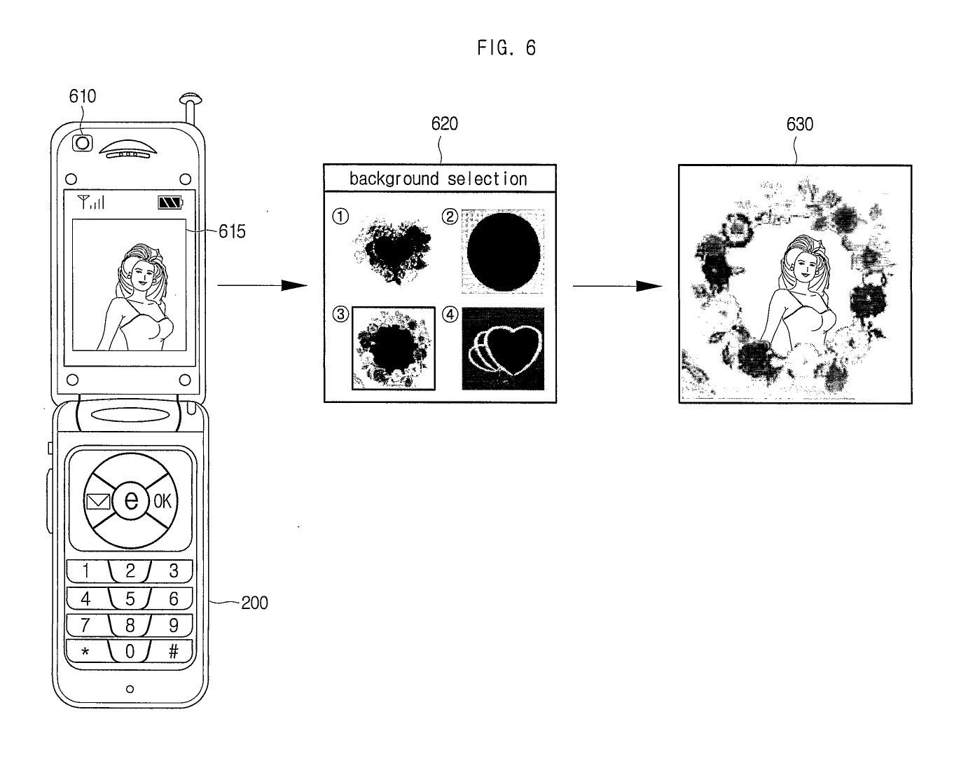

FIG. 3 is a flowchart of a method for combining images using the superimpose technique according to a preferred embodiment of the present invention, FIG. 4 illustrates an update state of region classification bit according to a preferred embodiment of the present invention, FIG. 5 illustrates example of preview memory usage according to a preferred embodiment of the present invention, and FIG. 6 illustrates a screen display for combining images using the superimpose technique according to a preferred embodiment of the present invention.

Referring to FIG. 3, the image file generating device 200 displays an external picture, which is inputted through the camera lens when the camera is functioning, on the display (step 305). At this time, the image file generating device 200 can convert the external picture inputted through the camera part 210 into digital data to temporarily store in a certain region of the memory 235 or the memory for preview and then output on the display.

In step 310, the image file generating device 200 checks whether the superimpose function is selected through the key input part 225. If the superimpose function is not selected, it returns to step 305. If the superimpose function is selected, it proceeds to step 315 to read background images pre-stored in a specific region of the memory 235 or a background image storing part and displays them on the video information display 230 for the purpose of combining images (i.e., perform the superimpose function). The background images may consist of a background region and a preview region, and the preview region can be filled with a predetermined color (e.g., black) for easy identification. Thus, pixel data values corresponding to the preview region among pixel data values of the background image can have a consistent value (e.g., “0000” in binary code) indicating the color.

In step 320, the image file generating device 200 receives a selection of background image from the user.

In step 325, the image file generating device 200 reads the background image, which is selected in step 320, from a specific region of the memory 235 or the background image storing part and writes in the memory for preview. At this time, data values corresponding to the background image are written in the memory for preview. The LSB of each pixel data value, as the region classification bit, is updated in association with the region where each pixel is located. Hereinafter, the description will assume that a region classification value for indicating the background region where the background image has to appear is “0” in binary code. Also, this description will assume that a region classification value for indicating the preview region where the real time external picture has to appear is “1” in binary code. As described above, among data values of the selected background image, the region classification bit in data value (e.g., 7b8d) of the color not appearing in the preview region is updated to the region classification value (i.e., 7b8c) indicating its presence in the background region and then stored. It can be easily understood that “d” in hexadecimal code is “1101” in binary code and “c” in hexadecimal code is “1100” in binary code. Of course, if the value of pre-existing region classification bit is identical to the region classification value to be updated to, it is not needed to update. Also, the region classification bit in data value (e.g., 0000) of the color is updated to the region classification value (i.e., 0001) for indicating its presence in the preview region and stored. As described above, the region classification value indicating where each pixel is located is updated and stored during the process of writing the user-selected background image in the memory for preview (or a specific region of the memory 235). Thus, the image file generating device 200 displays the external picture only on the position where the region classification value of a pixel is “1” in the later process. Thus, it is easy to determine which image will be displayed on that pixel just by checking the region classification bit in each data value of the background image stored in the memory for preview, not by using additional format data. The result of updated and stored values of region classification bit by the image file generating device 200 is shown in FIG. 4. Also, as described above, since the image file generating device 200 does not need format data, and as a result there is no need to store format data always in the memory 235 for the purpose of performing the superimpose function, it is possible to use the memory efficiently. Example usage of the memory for preview of the image file generating device 200, in comparison with the prior art, is shown in FIG. 5. As shown in FIG. 5, since format data must be needed in the prior art in performing the superimpose function, a format data storing region 520 must be assigned to the memory or an additional memory is required. It can be easily understood, however, that there is no format data storing region in the image file generating device 200.

Referring FIG. 3 again, in step 330, the image file generating device 200 reads the background image stored in a specific region of the memory 235 or the memory for preview. Then in step 335, an image corresponding to each pixel data value (i.e., pixel data value of which region classification bit is updated with the region classification value) is displayed on the video information display 230. At this time, the background image appears on the background region 410 and the real time external picture that the camera part 210 inputs appears on the preview region 420 in the image to be displayed on the video information display 230. Namely, more than two images coexist on different regions of the same display.

In step 340, the image file generating device 200 checks whether a capture instruction is inputted from the key input part 225. If the capture instruction is not inputted, it returns to step 335, and if the capture instruction is inputted, it proceeds to step 345 to generate an electronic file (i.e., digital image) corresponding to the combined image (i.e., more than two images coexisting on different regions of the same display) that is currently appearing on the video information display 230 and to store in a specific region of the memory 235 or a separate combined image storing part.

Hereinafter, the aforementioned combined image generation process will be described briefly with reference to the screen display illustrated in FIG. 6.

When a user initiates the camera function of the image file generating device 200, the external picture that is inputted through the camera lens 610 is displayed, like the screen 615, on the video display 230.

Then, if the user selects the superimpose function, the image file generating device 200 reads more than one background images from the memory 235 and displays, as in the screen 620, on the video information display 230. As shown in the screen 620, the background region and the preview region in each background image are distinguishable, and the preview region is filled with an arbitrary color.

Then, if the user selects any one of the background images, the selected background image is displayed on the video information display 230, and at the same time, the external picture that is inputted through the camera lens 610 is displayed on the preview region within the background image (screen 630). As described earlier, the region classification bit in each pixel data value corresponding to the background image when the user selects any one of background image is changed to a region classification value and stored.

If the user inputs the capture instruction in this state, the digital image corresponding to the screen 630 is newly generated and stored in the memory 235.

The accompanying drawings and detailed description are only an example of the present invention, serve only for describing the present invention, and by no means limit or restrict the spirit and scope of the present invention. Thus, any person of ordinary skill in the art shall understand that a large number of pernutations and other embodiments are possible. The true scope of the present invention must be defined only by the spirit of the appended claims.

### INDUSTRIAL APPLICABILITY

As described above, the present invention does not need additional format data when generating a combined image so that more efficient use of memory, without additional memory, is possible.

Moreover, the present invention can rapidly determine whether each pixel corresponds to the background region or the preview region by use of a minimum amount of data value, resulting in an increased efficiency of data processing.

What is claimed is

1. A method for combining images in an image file generating device with camera, comprising:
generating an updated background image by updating a value of region classification bit in pixel data value of an original background image selected from more than one original background images with a region classification value corresponding to region of each pixel, wherein the region classification bit indicates that the region of each pixel is one of a background region and a preview region;
displaying the updated background image on the background region and a picture image corresponding to an external picture being inputted through the camera on the preview region, wherein the background region and the preview region are distinguished by the region classification value; and
generating a digital image corresponding to the displayed updated background image and the displayed picture image.

2. The method of claim 1, wherein the preview region is filled with any color in the original background image and each pixel data value corresponding to the preview region has data value corresponding to the color.

3. The method of claim 1, wherein the region classification bit is LSB(Least Significant Bit) of the pixel data value.

4. The method of claim 1, wherein the region classification value classified into the background region or the preview region is binary 0 or binary 1.

5. An image file generating device with camera for combining a plurality of images, comprising:
a controller, the controller generating an updated background image by updating a value of region classification bit in pixel data value of the original background image with a region classification value corresponding to region of each pixel, wherein the region classification bit indicates that the region of each pixel is one of a background region and a preview region
a display unit, the display unit displaying the updated background image on the background region and a picture image corresponding to an external picture being inputted through the camera on the preview region, wherein the background region and the preview region are distinguished by the region classification value;
a digital image generating part, under the control of said controller, the digital image generating part generating a digital image corresponding to the displayed updated background image and the displayed picture image when the capture instruction is inputted; and
a memory, the memory storing more than one original background image, the updated background image, and the digital image.

6. The image file generating device of claim 5, wherein the preview region is filled with any color in the original background image and each pixel data value corresponding to the preview region has data value corresponding to the color.

7. The image file generating device of claim 5, the region classification bit is LSB(Least Significant Bit) of the pixel data value, wherein the region classification value classified into the background region or the preview region is binary 0 or binary 1.

8. A readable medium including a program containing executable instructions for performing the method for combining images in an image file generating device with camera, comprising:
generating an updated background image by updating a value of region classification bit in pixel data value of an original background image selected from more than one original background images with a region classification value corresponding to region of each pixel, wherein the region classification bit indicates that the region of each pixel is one of a background region and a preview region;
displaying the updated background image on the background region and a picture image corresponding to an external picture being inputted through the camera on the preview region, wherein the background region and the preview region are distinguished by the region classification value; and
generating a digital image corresponding to the displayed update background image and the displayed picture image.

9. The method of claim 1, further comprising: storing a digital image corresponding to the displayed updated background image and the displayed picture image when a capture instruction is inputted.

10. An image file generating device with camera for combining a plurality of images, comprising:
means for generating an updated background image by updating a value of region classification bit in pixel data value of an original background image selected from more than one original background images with a region classification value corresponding to region of each pixel, wherein the region classification bit indicates that the region of each pixel is one of a background region and a preview region;
means for displaying the updated background image on the background region and a picture image corresponding to an external picture being inputted through the camera on the preview region, wherein the background region and the preview region are distinguished by the region classification value; and
means for generating a digital image corresponding to the displayed updated background image and the displayed picture image.
